(19) United States
(12) Patent Application Publication
(10) Pub. No.: US 2009/0310340 A1
(43) Pub. Date: Dec. 17, 2009

(54) BATTERY POWERED ELECTRICAL FIRE

(76) Inventors: Martin Betz, Louth (IE); Aubrey O'Coimin, Louth (IE)

Correspondence Address: KUSNER & JAFFE;HIGHLAND PLACE SUITE 310, 6151 WILSON MILLS ROAD, HIGHLAND HEIGHTS, OH, 44143, US

(21) Appl. No.: 12/312,729

(22) PCT Filed: Nov. 23, 2007
(86) PCT No.: PCT/EP2007/062752

§ 371 Date: Aug. 18, 2009

(30) Foreign Application Priority Data
Nov. 24, 2006 (GB) 0623463.7

(51) Int. Cl. F21L 4/00

(52) U.S. Cl. 362/183; 362/157

(57) ABSTRACT

An electric fire configured to provide a simulated fire effect in response to activation of at least one light source. The fire including a battery which is useable to provide power to the at least one light source. The fire having a chassis providing a mount for the light source and a screen for displaying the fire effects and wherein the simulated fire effect is a flame effect and the screen displays flames in response to the light source output. The battery is a rechargeable battery. The fire includes a power connector which may be used to provide for a recharging of the battery such that the fire can be used independently of a mains power supply.

### FIELD OF THE INVENTION

The present invention relates to electric fires and in particular to an electric fire that is battery powered. The invention more particularly relates to a battery powered electric fire configured to provide flame effects. Suitably the fire may include one or more light emitting diodes (LEDs) to provide for internal illumination. A fire in accordance with the teaching of the invention may be utilised in an outdoor environment or in any other location where permanent connection to a mains power supply presents a difficulty.

### BACKGROUND

Electric fires are well known and are used to create the illusion of a real fire, typically in a domestic environment. The fires are useful to provide one or both of simulated flame or fuel effects. Where providing fuel effects, such fires may include a chassis that incorporates a fuel bed that simulates coals or logs. A flame effect is typically provided in a vertical orientation, the flames being provided in one of a number of different fashions, some of which are described in our earlier applications WO02068875. Such fires are also known to include one or more heating elements which may be combined with air blowers to generate heating effects.

In order to provide the necessary power to such devices, either for the lighting required in a generation of the flame or fuel effects or for powering the heating elements, it is known to couple such electric fires to a mains power supply. Such coupling is via a conventional power lead and requires a socket or other interface to the household mains.

While such arrangements are appropriate where a mains outlet is adjacent or convenient to the ultimate location of the fire, this is not always practical. Typically the power cord enters the chassis of the fire through a rear surface of the fire—so as to be relatively discreet when the fire is viewed from the front. Certain installations such as those that use existing fire place openings are not readily provided with such power outlets and it is not easy to route a power cord through to the interior portion of the fire place opening. This sometimes results with the installation requiring the running of a cord along the front of the fire place which is not aesthetically pleasing.

Despite these aesthetic disadvantages there are other locations where power is just not readily available. For example in mobile or temporary accommodations such as camping vans, caravans, mobile homes or the like mains power supply is a not always available. It would however be nice to be able to avail of the advantages of electric fire simulation arrangements.

Furthermore, it is becoming more and more common for people to use the outdoor environment of their gardens and patios for entertainment purposes. Most of the appliances that are used in this outdoor environment are either permanently fixed to the mains—such as outdoor lights and the like whose installation requires a qualified electrician—or are gas fuelled such as patio heaters and the like, or are operable using traditional fuels such as wood. It would be useful to be able to operate an electrical fire in such arrangements, but heretofore this has not been possible.

There are therefore a number of problems associated with such arrangements.

### SUMMARY

These and other problems are addressed by an electric fire in accordance with the teaching of the present invention that includes a battery which is useable to provide power to the at least one light source, the fire having a chassis providing a mount for the light source and a screen for displaying the fire effects and wherein the simulated fire effect is a flame effect and screen displays flames in response to the light source output, and wherein the battery is a rechargeable battery and the fire includes a power connector which may be used to provide for a recharging of the battery such that the fire can be used independently of a mains power supply.

Accordingly the invention provides a fire according to claim 1 with advantageous embodiments provided in the dependent claims thereto.

These and other features will be understood with reference to following drawings.

### BRIEF DESCRIPTION OF THE DRAWINGS

The present invention will now be described with reference to the accompanying drawings in which:

FIG. 1 is a section through an electric fire incorporating a battery in accordance with the teaching of the present invention.

FIG. 2 is a section through another electric fire, also including a battery, in accordance with the teaching of the invention.

FIG. 3 is an example of a further type of electric fire that is battery powered in accordance with the teaching of the invention.

FIG. 4 is a rear view of the fire of FIG. 3.

### DETAILED DESCRIPTION OF THE DRAWINGS

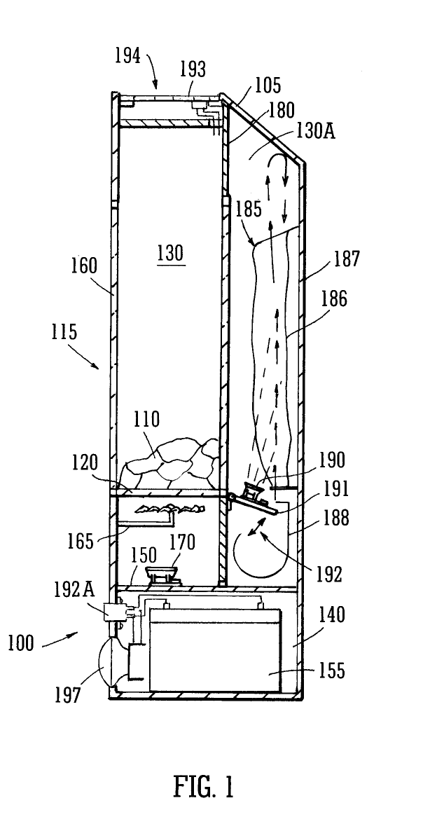

Preferred but exemplary embodiments of the invention will now be described with reference to FIGS. 1 to 4. Within the context of the present invention the arrangement of the flame or fuel simulation arrangements that are used to present the aesthetics of the fire will not be considered important as the advantage that is provided by the teaching of the invention is to provide power to the electric fire through a battery storage device, and the other features should not be considered critical as modifications can be made and will be apparent to the person skilled in the art without departing from the scope of the invention.

FIG. 1 shows in section view an electric fire 100 according to the teaching of the invention. The fire is configured to simulate the effect of a burning real fire and includes a chassis 105 within which a fuel bed 110 is mounted horizontally may comprise artificial coal or logs as desired. Other modifications to the arrangement of artificial fuel beds are well known and will not discussed herein.

The fuel bed may be considered as being located in a main upper compartment 130 of the fire and is separated from a main lower compartment 140 by a partition 150. The lower chamber 140 typically contains a battery 155 which provides power for the electrical elements of the fire. It is useful to locate the battery in a lower region of the fire, as the weight of the battery is such that location in this lower region provides additional stability to the fire.

As mentioned above the fuel bed 110 is located towards the front of the chassis. The main upper compartment 130 may be sealed at this front portion by a transparent panel 160, but of course this panel may be omitted. Where present, this panel may be made of glass or plastics, e.g. acrylic or perspex. Optionally the panel may be at least partially reflective such that in the absence of light to the rear of the panel, a user to the front of the fire may view their reflection.

It is known within the art to provide the fuel effect with a flickering pattern which may be generated through use of a flicker wheel 165 over a first light source 170 which is secured to the chassis. A rotation of the flicker wheel causes the simulated fuel bed to flicker thereby resembling glowing coals. The first light source is desirably of the type provided by one or more light emitting diodes (LEDs), and is orientated to shine light upwardly towards the fuel bed located thereabove.

A screen 180 extends upwardly from the simulated fuel bed 110 towards the upper part of the chassis 105. Screen 180 may be one or more panels having a partially reflecting surface and a diffusing surface. Suitably, screen 180 is made from a sheet of transparent material, such as glass, acrylic or perspex, having a lightly silvered surface on its front side (i.e. that side facing the front panel 160) and having, on its rear side, a diffusing surface.

Behind the screen 180, means 185 are provided for simulating a flame effect. Such means in the arrangement of FIG. 1, comprise a moveable fabric, 186, such as one or more fabric ribbons, which hangs in a substantially vertical and spaced relationship at the rear of the chassis. The fabric is arranged such that it will tend to ripple or undulate in a current of air provided by a small tangential fan unit 188 which is situated below the lower ends of the ribbons and which extends across most of the lower portion of an otherwise substantially airtight chamber 130a. Further information on the construction of such ribbons is found in our earlier British Patent, GB2230335.

Although not shown in this sectional view, a rear surface 187 of the chassis 105 may be provided with a patterned effect so as to resemble one or more flames. Such patterning may be achieved by providing regions of varying reflectivity and patterning the higher reflectivity regions to resemble flames. The patterned effect can be provided integrally on the rear surface or alternatively on a preformed panel that is then located on the rear surface. The patterned effect will be located behind the ribbons.

The rear surface 187 of the chassis is also illuminated using, in this example, a second light source 190. This second light source is preferably again of the type provided by one or more light emitting diodes (LEDs).

When the first and second light sources 170, 190 are switched on, the simulated fuel bed 110 is illuminated and the partially reflective surface of screen 180 provides an image of the fuel bed. The fan 188 creates undulating movement of the ribbons 186 and light from the second light source 190 is therefore reflected randomly onto the back of screen 180 so as to simulate flickering flames. This flickering image is perceived between the actual simulated fuel bed 110 and its image in the screen 180 so that the flames appear to be emanating from somewhere in the middle of an extended fuel bed.

Power to the electrical elements 170, 190, 188 may be provided by the battery 155 provided in the lower portion 140 of the fire. The battery is desirably a rechargeable battery whose charge can be provided by coupling the battery directly to a mains power supply using an appropriate connector 192. Another arrangement that could be used to recharge the battery would be through use of a solar cell 193 located on an upper surface 194 of the fire. The operation of such solar cells will be apparent to the person skilled in the art, suffice to say that when illuminated with solar energy, the cell generates an electrical current that can be used to recharge the battery.

While not required, optionally a fire in accordance with the teaching of the invention may include a radiant heat source such as a radiant bulb 197 locatable in a front panel of the fire and also being battery powered. Depending on the rating of the battery, other power sources could also be used. A fire in accordance with the teaching of the invention could be provided in either a battery only mode or an arrangement where a battery could be used at certain times and a connection to the mains power at other times. In this way certain functionality of the fire could be deactivated in situations where there was insufficient power available to power all available functions of the fire.

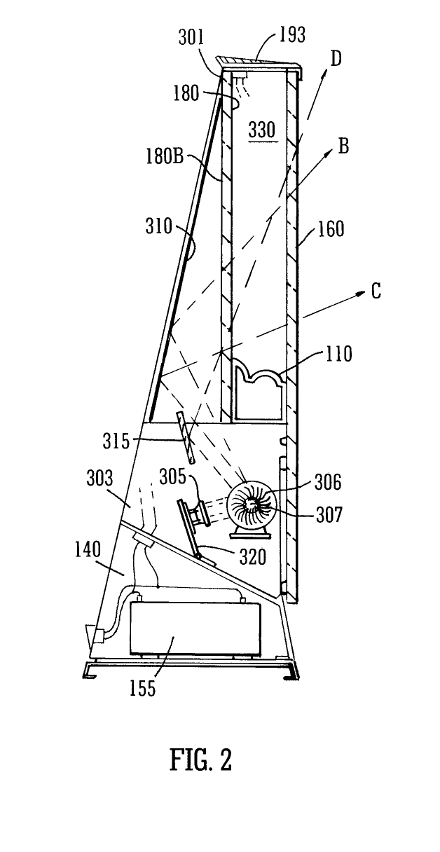

FIG. 2 shows another embodiment of a fire 300 in accordance with the teaching of the invention which also uses one or more LED's for internal illumination of the fire but does not include moveable fabrics to create the flame effect. In this embodiment the same reference numerals are used for components already described with reference to FIGS. 1. The fire includes a chassis 301, that houses a fuel bed 110 that is located in front portion of a main upper compartment 330. The fuel bed 110 is positioned in front of a light diffusing and reflecting screen 180, which reflects an image of the fuel bed. A light source in the form of one or more LEDs 305 is positioned in a lower main compartment 303 and directly illuminates strips of foil 306 on a rotor 307, whereby moving beams of light (B, C) are reflected from a rear reflector 310 onto an inner surface 180b of the screen 180. The foil and rotor collectively are referred to as a rotisserie. When the rotisserie rotates, moving beams of light appear like flickers moving upwardly on the screen 180. An auxiliary reflector 315 reflects moving beams along another path (D) to be viewed by a viewer nearer to the appliance.

This arrangement differs from that of FIG. 1 in that the flame effect means do not require an air blower, simply the motor used to drive the rotisserie. As such the power consumption is lower. Furthermore a separate light source is not required for both the fuel bed 110 and the provision of the flame effects.

Similarly to FIG. 1, the fire houses a battery 155 located in the base of the chassis and orientated to provide power to the LEDs providing the internal illumination.

Similarly to what was described with reference to FIG. 1, a translucent panel 160 may be provided in front of the fuel bed.

The invention has heretofore been described with reference to LEDs mounted within an electric fire but no mention has been made of the type of LEDs or the type of mounting arrangement for them. It is envisaged that fires in accordance with the teaching of the invention could be used with standard LEDs, ultrabrite monocolour LEDs or with multi-coloured LEDs. It will be understood that the use of LEDs provides a number of advantages over the prior art filament arrangements such as:

1) Longer life: LEDs are rated up to 100,000 hours life (over 22 years at 12 hours per day)

2) Lower power consumption (up to 80% less). Existing bulb power consumption is about 100 watts. LED total power consumption in comparison is about 21 watts.

3) Durable (LED modules will not break like standard glass bulbs

4) Increased reliability which has the potential to minimise cost associated with servicing and support.

5) Less waste heat produced

6) High efficiency.

As a result of their lower power requirements it will be understood that such light sources are particularly suitable for battery powered appliances where a connection to the mains power is not readily available. While the invention has been discussed in generalities above, the following examples show typical power requirements for different configurations of a fire in accordance with the teaching of the invention.

### EXAMPLE 1

4 multi-coloured leds with associated optics. (1 watt Red, Green and blue leds). (9 Watts)

Electronic dimming, control and driving circuitry. (1 watt)

Flags with fan Blower. (11 watts)

Total Power consumption 20 watts.

| Electronic | | | Usage | Watt |
|---|---|---|---|---|
| Component | Loading | * | (Hours) | Hours |
| LEDs | 9 | * | 12 | 108 |
| Electronic | 1 | * | 12 | 12 |
| circuitry | | | | |
| Flags with | 11 | * | 12 | 132 |
| fan Blower | | | | |

Total Watt Hours = 252 watt hours
252 watt hours/12 volts = 21 amp hours

Therefore if we wish to run the fire for 1 week @2 hour a day then we would need to use a battery rated for at least 22 Ahr @12 volts. In summary the fire could run continually for 12 hrs, doubling the capacity of the battery would mean it could run for 24 hrs and so forth. Each fire would be supplied complete with standard charger; car/caravan charger and DC plug adapter kit

### EXAMPLE 2

4 single white/amber leds with associated optics. (4 Watts)

Electronic dimming, control and driving circuitry. (0.2 watt)

Rotisserie motor. (2.0 watts)

Total Power consumption 6.2 watts.

| Electronic | | | Usage | Watt |
|---|---|---|---|---|
| Component | Loading | * | (Hours) | Hours |
| Leds | 4 | * | 12 | 48 |
| Electronic | 0.2 | * | 12 | 2.4 |
| circuitry | | | | |
| Rotisserie motor | 2.0 | * | 12 | 24 |

Total Watt Hours = 74.4 watt hours
74.4 watt hours/12 volts = 6.2 amp hours

Therefore if we wish to run the fire for 1 week @2 hours a day then we would need to use a battery rated for at least 7 Ahr @12 volts. In summary this fire could run continually for 12 hrs, doubling the capacity of the battery would mean it could run for 24 hrs and so forth. Each fire could be supplied complete with standard charger; car/caravan charger and DC plug adapter kit

### EXAMPLE 3

2 single white/amber leds with associated optics. (2 Watts)

Electronic dimming, control and driving circuitry. (0.2 watt)

Rotisserie motor. (2.0 watts)

Total Power consumption 4.2 watts.

| Electronic | | | Usage | Watt |
|---|---|---|---|---|
| Component | Loading | * | (Hours) | Hours |
| Leds | 2 | * | 12 | 24 |
| Electronic | 0.2 | * | 12 | 2.4 |
| circuitry | | | | |
| Rotisserie motor | 2.0 | * | 12 | 24 |

Total Watt Hours = 50.4 watt hours
50.4 watt hours/12 volts = 4.2 amp hours

Therefore if we wish to run the fire for 1 week @2 hours a day then we would need to use a battery rated for at least 5 Ahr @12 volts. In summary this fire could run continually for 12 hrs, doubling the capacity of the battery would mean it could run for 24 hrs and so forth.

In all three examples, the battery calculations are based on running the three product variants for a 12 hour period and the resultant power requirements are listed. In summary, the above results show that it is possible to have a number of different configurations all powered using a battery. The above calculations show that it is feasible to efficiently use a battery powered fire to provide for a display of flame effects over a reasonable time period-reasonable in the context that persons don't normally sit in front of the fire for time periods in excess of those mentioned above. While described in the context of LED light sources it will be understood that low wattage tungsten filament bulbs could equivalently be used. In all scenarios there is a trade off between the bulb consumption, the battery type and the type of usage.

As discussed heretofore, a fire in accordance with the teaching of the invention employs one or more LEDs to provide internal illumination to simulate fire effects. In the embodiments described with reference to FIGS. 1 and 2, the fire is of a type that includes a partially reflective screen located immediately behind the fuel bed to provide an effect where flames generated appear to be emanating from within a mid-portion of the fuel bed. Other arrangement of electrical fires which do not include such a visual effect may be equally provided by a battery powered fire in accordance with the teaching of the invention. The fires of FIGS. 1 and 2 generate the flame effect using internal lighting. These fires can be wall mounted or free standing.

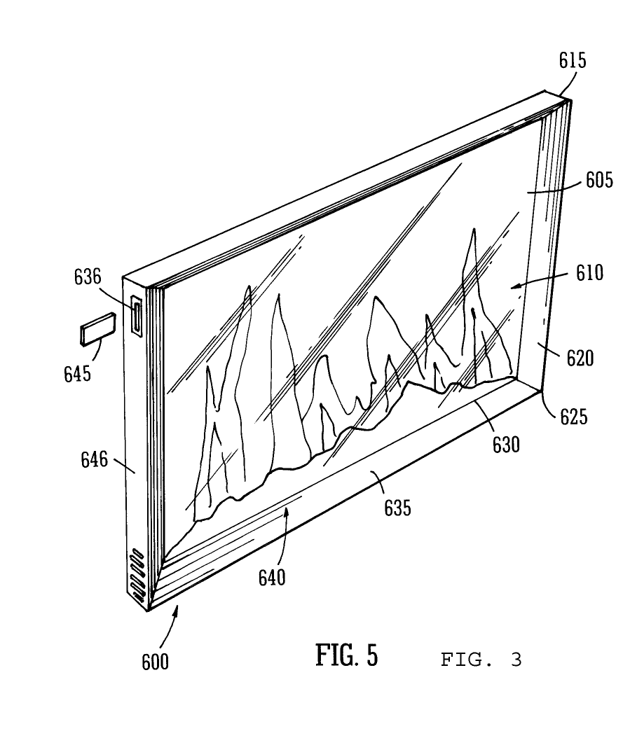

FIG. 3 shows an example of an alternative configuration for a battery operated fire in accordance with the teaching of the invention. In this arrangement of the fire, as opposed to using mechanical arrangements to generate the flame effects, the fire incorporates an electrically stimulated screen. Such an arrangement is typically slimmer than those of the arrangements of FIGS. 1 and 2.

The fire 600 includes a flat panel display screen 605 which is configured to display images of a burning fire 610, which is exemplary of the type of wall mounted fire that could be battery powered in accordance with the teaching of the invention. The display may be selected from one of a variety of different flat panel display types such as plasma screens, liquid crystal displays (LCD's) or the like as will be well apparent to those skilled in the art. The display is mounted within a frame 615, that provides a tapered surface 620 from a front edge portion 625 which is distally located from the screen to a rear edge portion 630 which is coincident with the screen. The tapering effect is chosen so as to increase the apparent depth of view of the displayed images on the screen 605. A glass sheet 635 whose footprint may be the same or larger than that of the display panel may be mountable to the front edge portion of the frame such that once mounted that the image 610 is viewable through the sheet. Once mounted the area between the tapered surface 620 of the frame 625, the display panel 605 and the sheet 635 defines an air volume 640. This volume may be vented through the provision of vents provided surfaces of the frame.

In a preferred embodiment, the glass sheet 635 is provided as a smoked glass sheet or a partially mirrored sheet. Using such glass within the context of the provision of a simulated fireplace is advantageous for at least two reasons. Firstly, when the image is not being displayed, the darkness of the glass occludes the frame and display panel behind. As such if the fireplace is mounted to a wall, all that is visible in the context of the smoked sheet is a darkened glass sheet, which is aesthetically pleasing. In the context of a mirrored sheet one would see one's own reflection. Of course the configuration of the glass could also be altered to provide for different shapes. Once the display is effected, the flame effects 610 are visible through the glass.

The fire of FIG. 3 uses a screen 605 such as an LCD screen that displays images of flames in response to electrical stimulation. The screen may be considered as comprising a plurality of individual light sources which are individually illuminated to achieve a desired lighting affect on the screen. In this way the light source and screen of FIG. 3 are integrally formed, whereas in the mechanical arrangements of FIGS. 1 and 2 they were separately formed within the housing. As the images displayed using such a fire are electronically driven, it is necessary for some storage device to be provided which can provide a storage of the necessary images.

In one arrangement such storage is provided by having a removable memory card 645. A slot 636 is provided on a side wall 646 of the frame 615 and is dimensioned to receive the memory card 645. The memory card is desirably of the type known as a flash memory card—such as those for use in digital cameras and known as Secure Digital (SD), CompactFlash (CF), SmartMedia (SM), Memory Stick (MS), MultiMediaCard (MMC), xD-Picture Card (xD) and the like. Such memory cards are typically provided with a total memory capacity of about 32 MB to about 2 GB.

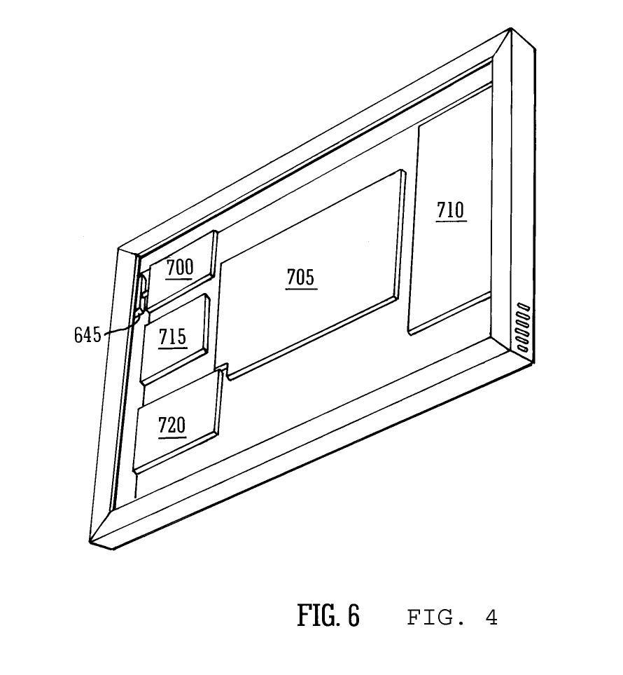

FIG. 4 is a view from the rear of the fireplace with the back cover removed so as to show internal electrical components which are illustrated in schematic form as the specifics of their operation will be apparent to the person skilled in the art. If present, the memory card 645, once inserted into the slot 636 on the side of the frame is received within a card reader circuit 700. The card reader 700 is in electrical communication with a controller 705 which is communicatable with a user interface 710. The user interface may include a remote control interface to enable a user to control the operation of the fireplace using a remote control. Once the user selects a desired function that is communicated from the user interface 710 to the controller 705 which then selects the stored image from the memory card and displays them on the screen. The desired function may include one or more of user controlled parameters such as sound level, light intensity, length of sequence and the like. An internal hard drive 715 or other storage device may be provided which is also suitably controlled using the controller 705 in combination with the user interface 710.

The entire operation of the fire may be powered using a battery pack 720, such as that provided using a lithium ion arrangement such as those known for portable electronics equipment. These devices are rechargeable and such recharging could be effected by either providing a power cable that could interface with the fire and effect the recharging at periodic intervals, provide a recharge capacity through use of solar cells or the like, or indeed provide a removable battery facility where the battery could be periodically replaced.

Typical power requirements for screens that could be incorporated within the fire of the invention will depend on their dimensions but the following table will give an example of some exemplary figures:

| | | Typical power |
|---|---|---|
| | Portable LCD Display Type | consumption |
| 1 | 12.1-inch XGA | 2.5-4.0 W |
| 2 | 14.1-inch SXGA+ | 3.5-4.4 W |
| 3 | 15.1-inch SXGA | 5.0-7.0 W |
| 4 | 17.1-inch SXGA | 7.0-10.0 W |

The internal processing cards that are required to drive such components will typically require about 6 W processing powers. It will be apparent that such figures of power consumption could easily be achievable over a time period of 3-4 hours (typical continuous usage time for a flame effect fire) on one battery usage.

What has been described herein are exemplary embodiments of a electric fire that is powered using a battery. In a first embodiment, the battery provides power for one or more LEDs which are used for internal illumination purposes. The use of such LEDs provides for improved performance and characteristics of the fire. In a second embodiment the battery provides power for the electronic screen which is activated to display images of a fire. The type of battery that is useable within the context of the present invention will vary depending on the power requirements, the recharge availability or indeed whether it is desired to recharge at all. Some fires could be useable with disposable or replaceable batteries and as long as the power requirement of such fires are chosen judiciously it is possible to provide a fire with extended usage irrespective of the type of battery chosen. Where replaceable batteries are to be used it is preferable that such batteries are housed within the fire that makes them readily accessible to a user for replacement purposes. Typically this will be provided by having a front access to the battery housing.

The fires heretofore described are useful in any environment where power connection to a mains power supply is not readily accessible. Such environments include insert fires where there is not a convenient power source. Even in a domestic household, such fires could be used in the traditional fire openings and when the fire is not being used could be recharged by running a power cable to the fire. When the fire is being used the power cable could be removed to improve the aesthetics of the appearance.

The fire could be provided in configurations that allow operation in one of two modes, a mains connected mode wherein the fire is connected to and powered by a mains power supply and a battery mode wherein the fire is powered by a battery. In such arrangements, the fire would judiciously include selection means, desirably implemented in hardware or software and configured to automatically determine the appropriate mode for operation of the fire. Of course manual means could also be selected. By providing such multi-mode operation it is possible that during the battery mode selected features of the fire are disabled, the features being activated during the mains connected mode. This could be used to lengthen the use of the fire while on batteries by for example disabling power hungry components such as heaters and the like. For example, in the battery mode the flame and/or fuel effects may be enabled. For example in the mains power supply mode, the recharge function to facilitate a recharge of the battery, and the fire heating functions may be enabled. The fire may further be operable in a recharge mode where during recharge features other than those required for recharging the battery are disabled.

Other operation environments for such fires includes an outdoor environment. While some weather proofing of the fire may be required, it will be understood that by providing a battery powered fire, it is possible for a user outside to create flame effects where previously this was not possible. Such an arrangement may be recharged using a power cable that can be run to a power source, or as the fire is outside can be re-charged using solar cells.

The skilled person will appreciate that weather proofing of the fire may include provision of additional seals, provision of water resistant coverings or coatings, insulation or other suitable weather proofing means.

Advantageously by virtue of the battery power facility, and being free of the need to have a continuous power connection, the fire of the invention is highly portable. The fire of the invention is further a self standing fire which includes all the expected fire functions for example flame effects, fuel means and heating functions. As such the invention provides the user with excellent flexibility and versatility and freedom in how the fire is used and where it is located for a particular use.

In comparison with other fires of the prior art, the fire of the invention has relatively low energy requirements, and/or may be configured for operation in a low energy mode. This has the advantage, that the fire of the invention is suitable for operation by means of a battery source for a reasonable duration of time.

While preferred embodiments have been described with reference to the figures modifications can be made without departing from the scope of the invention which is to be limited solely by the claims. Where integers or components are described with reference to one figure it will be understood that they can be interchanged with those of another Figure without departing from the context of the invention.

The words comprises/comprising when used in this specification are to specify the presence of stated features, integers, steps or components but does not preclude the presence or addition of one or more other features, integers, steps, components or groups thereof.

1. An electric fire configured to provide a simulated fire effect in response to activation of at least one light source and wherein the fire includes a battery which is useable to provide power to the at least one light source, the fire having a chassis providing a mount for the light source and a screen for displaying the fire effects and wherein the simulated fire effect is a flame effect and screen displays flames in response to the light source output, and wherein the battery is a rechargeable battery, coupled to one or more solar cells which are useable to effect a recharging of the battery, and the fire includes a power connector which may be used to provide for a recharging of the battery such that the fire can be used independently of a mains power supply.

2. The fire of claim 1 wherein the fire is operable in a mains connected mode wherein the fire is connected to and powered by a mains power supply, and a battery mode wherein the fire is powered solely by the battery.

3. The fire as claimed in claim 1 further including simulated fuel means to simulate a bed of combusting fuel.

4. The fire as claimed in claim 3 wherein the screen includes the simulated fuel means.

5. The fire as claimed in claim 4 wherein the light source and screen are integrally formed.

6. The fire as claimed in claim 5 wherein the flames are provided in response to an electrical stimulus of the screen.

7. The fire as claimed in claim 1 wherein the light source includes at least one light emitting diode (LED).

8. The fire as claimed in claim 7 further including flame effect means, the flame effect means and light source combining to provide for displayed flames on the screen.

9. The fire as claimed in claim 8 wherein the screen is positioned in front of said flame effect means, the screen being capable of diffusely transmitting light reflected by said flame effect means.

10. The fire as claimed in claim 9 further including simulated fuel means provided to simulate a bed of fuel, the screen being positioned between the simulated fuel means and the flame effect means.

11. The fire as claimed in claim 1 wherein the simulated fire effects are controllable using an electric controller.

12. The fire as claimed in claim 11 wherein the electric controller is a remote control.

13. The fire as claimed in claim 11, wherein the fire effects are related to the output of at least one LED and wherein the at least one LED is controllable using the electric controller such that application of a suitable control signal from the controller effects a change in the output of the LED and a subsequent change in the generated fire effects.

14. The fire of claim 3 wherein the screen is also capable of reflecting light from said simulated fuel means so that the simulated flames appear to emanate between the simulated fuel means and an image of the latter means reflected in said screen means.

15. The fire of claim 8 wherein said flame effect means comprises moveable material supported so as to be capable of movement, and means for causing said movement.

16. The fire of claim 15 wherein said material is a fabric in the form of a plurality of vertically arranged ribbons locatable in a rear portion of the chassis behind the screen, the screen separating the ribbons from the fuel bed.

17. The fire of claim 15 wherein the means for causing movement is an air blower configured to direct air onto the moveable material to impart movement.

18. The fire of claim 8 wherein the flame effects means includes reflective strips having either the same, or different colours, the reflective strips being mounted on a rotatable shaft, the shaft being connected to drive means for rotating the shaft.

19. The fire of claim 18 wherein the reflective strips are circumferentially arranged about the rotatable shaft, the shaft being located in a lower region of the chassis below the screen.

20. The fire according to claim 1 wherein said screen is a translucent or transparent panel or panels having a reflective surface and a diffusing surface.

21. The fire according to claim 20 in which said screen means is a single panel having a lightly reflective front surface and a diffusing rear surface.

22. The fire according to claim 1 having a front panel through which the screen is visible.

23. The fire according to claim 22 wherein said transparent front panel has an at least partially mirrored front surface.

24. The fire as claimed in claim 1 being wall mountable.

25. The fire of claim 1 further including a remote control, which may be used to control the output of the fire.

26. (canceled)

27. The fire as claimed in claim 1 wherein the power connector enables a coupling of the fire to a mains power supply to provide for a recharging of the battery.

28. The fire as claimed in claim 2 wherein the fire includes selection means configured to determine the appropriate mode for operation of the fire.

29. The fire as claimed in claim 2 wherein during the battery mode selected features of the fire are disabled, the features being activated during the mains connected mode.

30. The fire as claimed in claim 2 wherein in the battery mode the flame and/or fuel effect features of the fire are enabled.

31. An outdoor battery operated fire configured to provide for one or more of flame and/or fuel effects, the fire including a fire comprising:
a battery which is useable to provide power to at least one light source, the fire having a chassis providing a mount for the light source and a screen for displaying the fire effects and wherein the simulated fire effect is a flame effect and screen displays flames in response to the light source output, and wherein the battery is a rechargeable battery, coupled to one or more solar cells which are useable to effect a recharging of the battery, and the fire includes a power connector which may be used to provide for a recharging of the battery such that the fire can be used independently of a mains power supply.

32. A fire as claimed in claim 31, wherein the fire is weatherproofed for use outdoors.

33. (canceled)

34. A solar powered electric fire configured to provide a simulated fire effect in response to activation of at least one light source and wherein the fire includes a battery which is useable to provide power to the at least one light source, and wherein the battery is a rechargeable battery, coupled to one or more solar cells which are useable to effect a recharging of the battery.
